(19) United States
(12) Patent Application Publication
(10) Pub. No.: US 2025/0385036 A1
(43) Pub. Date: Dec. 18, 2025

(54) FIGURE EIGHT-SHAPED INDUCTOR

(71) Applicant: STMicroelectronics International N.V., Geneva (CH)

(72) Inventors: Fernando BARRERA CERVANTES, Grenoble (FR); Helene ESCH, Seyssinet Pariset (FR); Philippe LEVEL, Saint Egreve (FR); Fabien SORDET, Colombe (FR)

(73) Assignee: STMicroelectronics International N.V., Geneva (CH)

(21) Appl. No.: 19/237,874

(22) Filed: Jun. 13, 2025

(30) Foreign Application Priority Data
Jun. 18, 2024 (FR) FR2406445

(51) Int. Cl. H01F 27/28

(52) U.S. Cl. CPC H01F 27/2804; H01F 2027/2809

(57) ABSTRACT

A figure eight-shaped inductor includes, in a first conductive layer, an exterior loop of a first part of the inductor connected to a first exterior partial loop of a second part of the inductor and further connected to one or more interior loops of the first part, the exterior loop and the interior loops of the first part being concentric, and one or more interior loops of the second part connected to a second exterior partial loop of the second part, the exterior partial loops and the interior loops of the second part being concentric. The inductor further includes, in a second conductive layer, a conductive link connecting through a vie to the interior loops of the first part and connected through a via to the interior loops of the second part.

### PRIORITY CLAIM

This application claims the priority benefit of French Application for Patent No. FR2406445, filed on Jun. 18, 2024, the content of which is hereby incorporated by reference in its entirety to the maximum extent allowable by law.

### TECHNICAL FIELD

The present disclosure relates generally to inductors and, in particular, to inductors having figure eight shape (i.e., any of various forms or representations having the form or shape of the Arabic numeral eight), methods of using figure eight-shaped inductors, and methods of manufacturing figure eight-shaped inductors.

### BACKGROUND

An inductor is an electronic component comprising one or more conductive loops connected in series between two connection terminals, sometime referred to as the ends or terminals of the inductor. The inductance value, expressed in Henry, represents the inductor's ability to store energy in the form of a magnetic field when an electric current is passed through it. The higher the number of loops in the inductor, the higher the inductance value.

However, the magnetic field radiated by an inductor can cause unwanted coupling with nearby electronic components. Figure eight-shaped inductors (i.e., those having windings with a figure eight shape) have been developed to reduce the parasitic mutual inductance, i.e. the magnetic coupling with other devices, while still offering high self-inductance values. Reference is made to Poon, et al., “Reduction of Inductive Crosstalk Using Quadrupole Inductors”, IEEE Journal of Solid-State Circuits, 2009 (incorporated herein by reference) which details advantages of figure eight-shaped inductors.

In microelectronics, the loops of an induction coil are materialized by conductive tracks in a stack of conductive and insulating layers on a substrate. When two conductive tracks of a given loop formed in a given conductive layer of the stack are to cross, a link is formed using vias and a portion of track in another conductive layer in order to form a bridge. However, a drawback of figure eight-shaped inductors is that they tend to comprise a relatively high number of such links, leading to a poor quality factor of the inductor.

There is a need for an improved figure eight-shaped inductor.

### SUMMARY

According to one aspect, there is provided a figure eight-shaped inductor, comprising: in a first conductive layer of a stack of insulating and conducting layers: an exterior loop of a first part of the inductor having a first end connected to an end of a first exterior partial loop of a second part of the inductor and a second end connected to a first end of one or more interior loops of the first part of the inductor, the exterior loop and the one or more interior loops of the first part being concentric; and one or more interior loops of the second part of the inductor having a first end connected to an end of a second exterior partial loop of the second part of the inductor, the first and second exterior partial loops and the one or more interior loops of the second part being concentric; the inductor further comprising a conductive link connecting a second end of the one or more interior loops of the first part of the inductor to a second end of the one or more interior loops of the second part of the inductor, the conductive link being partially in a second conductive layer.

According to one embodiment, a current applied between a first terminal and a second terminal of the inductor flows in a first direction of rotation in the exterior loop and the one or more interior loops of the first part and in a second direction of rotation opposite to the first direction in the first and second exterior partial loops and the one or more interior loops of the second part.

According to one embodiment, in the first part, a first width of the exterior loop is larger than a second width of the one or more interior loops and wherein, in the second part, a third width of the first and second exterior partial loops is larger than a fourth width of the one or more interior loops.

According to one embodiment, the second conductive layer is closer to the substrate than the first conductive layer.

According to one embodiment, the first conductive layer is closer to the substrate than the second conductive layer.

According to another aspect, there is provided an integrated circuit, comprising at least one inductor as described above.

According to another aspect, there is provided a voltage-controlled oscillator comprising at least one inductor as described above.

According to another aspect, there is provided a transmitter comprising at least one inductor as described above.

According to another aspect, there is provided a method, comprising: applying a current, by an electronic circuit, to a figure eight-shaped inductor, comprising: in a first conductive layer of a stack of insulating and conducting layers: an exterior loop of a first part of the inductor having a first end connected to an end of a first exterior partial loop of a second part of the inductor and a second end connected to a first end of one or more interior loops of the first part of the inductor, the exterior loop and the one or more interior loops of the first part being concentric; and one or more interior loops of the second part of the inductor having a first end connected to an end of a second exterior partial loop of the second part of the inductor, the first and second exterior partial loops and the one or more interior loops of the second part being concentric; the inductor further comprising a conductive link connecting a second end of the one or more interior loops of the first part of the inductor to a second end of the one or more interior loops of the second part of the inductor, the conductive link being partially in a second conductive layer; and transmitting the current through the inductor.

According to one embodiment, the current is applied to a first terminal of the inductor; the current is transmitted from the first terminal to a second terminal of the inductor; and the current is supplied at the second terminal of the inductor.

According to another aspect, there is provided a method of manufacturing a figure eight-shaped inductor, the method comprising: in a stack of insulating and conducting layers: forming, in a first conductive layer of the stack, an exterior loop of a first part of the inductor having a first end connected to an end of a first exterior partial loop of a second part of the inductor and a second end connected to a first end of one or more interior loops of the first part of the inductor, the exterior loop and the one or more interior loops of the first part being concentric; forming, in the first conductive layer of the stack, one or more interior loops of the second part of the inductor having a first end connected to an end of a second exterior partial loop of the second part of the inductor, the first and second exterior partial loops and the one or more interior loops of the second part being concentric.

According to one embodiment, the method of manufacturing the figure eight-shaped inductor further comprises, after forming the first conductive layer: forming a first via contacting a second end of the one or more interior loops of the first part of the inductor; forming a second via, contacting a second end of the one or more interior loops of the second part of the inductor; and forming, in a second conductive layer of the stack, a conductive link connecting the first via and the second via.

According to one embodiment, the method of manufacturing the figure eight-shaped inductor further comprises, before forming the first conductive layer: forming, in a second conductive layer of the stack, a conductive link; forming a first via, contacting a first end of the conductive link and further contacting a second end of the one or more interior loops of the first part of the inductor; and forming a second via, contacting a second end of the conductive link and further contacting a second end of the one or more interior loops of the second part of the inductor.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 illustrates a layout of a figure eight-shaped inductor comprising two loops;

FIG. 2 illustrates another layout of a figure eight-shaped inductor comprising four loops;

FIG. 3 illustrates a figure eight-shaped inductor comprising four loops;

FIG. 4 illustrates a figure eight-shaped inductor comprising six loops;

FIG. 5 is a graph showing an example of the inductance value of the inductors of FIG. 2 and FIG. 3 as a function of the frequency of an alternating current passing therethrough;

FIG. 6 is a graph showing an example of the quality factor of the inductors of FIG. 2 and FIG. 3 as a function of the frequency of an alternating current passing therethrough;

FIG. 7 schematically illustrates a transmitter in which the figure eight-shaped inductor of FIG. 3 or FIG. 4 may be incorporated;

FIG. 8 schematically illustrates a transmitter in which the figure eight-shaped inductor of FIG. 3 or FIG. 4 may be incorporated;

FIG. 9 schematically illustrates an integrated circuit comprising the figure eight-shaped inductor of FIG. 3 or FIG. 4; and

FIG. 10 illustrates a layout of one conductive layer of the figure eight-shaped inductor of FIG. 3.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, the processes involved in the manufacturing of an inductor are known to a person skilled in the art and will not be detailed in the description.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

In the following description, inductors formed in a circuit comprising a stack of insulating and conducting layers lining a substrate are considered. Other electronic components may also be integrated in the circuit and connected to the inductor via conductive tracks in the stack.

The term “conductive layer” is used herein to designate a single layer of the stack comprising a set of conductive tracks formed of a conductive material, such as a metal, e.g., copper, surrounded by an insulating material, such as silicon oxide.

The term “loop”, when referring to an inductor, is used to designate a single conductive track of the inductor that turns by at least 270°, or one or more conductive tracks of the same or different conductive layers of the inductor, connected to each other so as to be electrically equivalent to a single conductive track that turns by at least 270°. Loops can have any shape, for example orthogonal, hexagonal, circular, square, rectangular, etc.

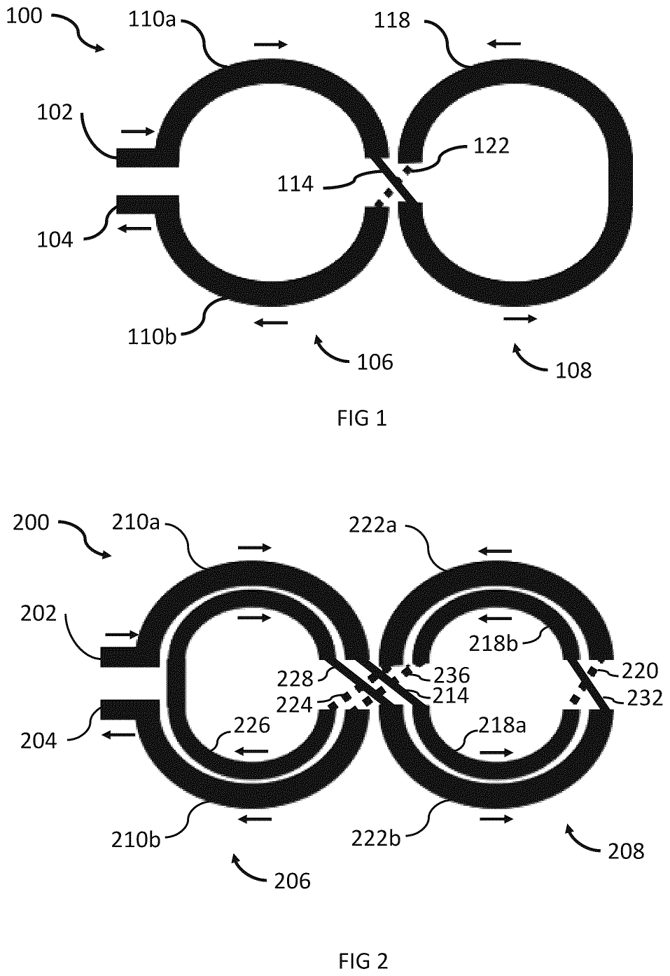

FIG. 1 illustrates a layout of a figure eight-shaped inductor 100 comprising two loops.

The inductor 100 comprises a first terminal 102 and a second terminal 104 that are each configured to receive and/or supply a current. The figure eight-shaped inductor 100 comprises a first part 106 of the figure eight shape connected to the terminals 102, 104, and a second part 108 of the figure eight shape connected to the first part. The first part 106 comprises a first partial loop 110a. A first end of the first partial loop 110a is connected to the first terminal 102.

A second end of the first partial loop 110a is connected to a first end of a first conductive link 114. A second end of the first conductive link 114 is connected to a first end of a loop 118 of the second part 108 of the inductor 100. A second end of the loop 118 is connected to a first end of a second conductive link 122. A second end of the conductive link 122 is connected to a first end of a second partial loop 110b of the first part 106. A second end of the second partial loop 110b is connected to the second terminal 104.

The partial loops 110a and 110b are in the first part 106 of the inductor and together form a loop 110 of the inductor 100. The loops 118 and 110 are connected in series, for example through the conductive links 114 and 122, and together define the form or shape of the Arabic numeral eight (i.e., figure eight-shaped).

The first terminal 102, the second terminal 104, the loop 110, the first conductive link 114 and the loop 118 are formed in a first conductive layer of the inductor 100.

The second conductive link 122 is formed in part in a second conductive layer of the inductor.

The second conductive link 122 comprises a first via at its first end and a second via at its second end to connect the first and the second conductive layers.

The inductive loops of the first part 106 and second part 108 are arranged such that current flows through them with opposite rotation, in other words the current flows clockwise in one of the loops, and counter-clockwise in the other loop. For example, when a current is flowing from the terminal 102 to the terminal 104 of the inductor, in a direction indicated by arrows in FIG. 1, the current is flowing clockwise in the loop 110 and counter-clockwise in the loop 118. Similarly, when a current is flowing in the opposite direction to the direction of the arrows, that is from the terminal 104 to the terminal 102 of the inductor, the current is flowing counter-clockwise in the loop 110 and clockwise in the loop 118. Since the orientation of the magnetic field in each loop varies with the clockwise or counter-clockwise orientation of the current flow, from a distance, the magnetic field generated by the loop 118 at least partially cancels the magnetic field generated by the loop 110. Therefore, the inductor 100 has a reduced impact on neighboring electronic components.

FIG. 2 illustrates another layout of a figure eight-shaped inductor 200 comprising four loops.

The inductor 200 comprises a first terminal 202 and a second terminal 204 that are configured to receive and/or supply a current. The figure eight-shaped inductor 200 comprises a first part 206 of the figure eight shape connected to the terminals 202, 204, and a second part 208 of the figure eight shape. The first part 206 comprises a first exterior partial loop 210a. A first end of the first exterior partial loop 210a is connected to the first terminal 202 and a second end of the first exterior partial loop 210a is connected to a first end of a first conductive link 214. A second end of the first conductive link 214 is connected to a first end of a first interior partial loop 218a of the second part 208. A second end of the first interior partial loop 218a is connected to a first end of a second conductive link 220. A second end of the conductive link 220 is connected to a first end of a first exterior partial loop 222a of the second part 208. A second end of the first exterior partial loop 222a is connected to the first end of a third conductive link 224. A second end of the third conductive link 224 is connected to the first end of a first interior loop 226 of the first part 206. A second end of the first interior loop 226 is connected to a first end of a fourth conductive link 228. A second end of the conductive link 228 is connected to a first end of a second exterior partial loop 222b of the second part 208. A second end of the second exterior partial loop 222b is connected to the first end of a fifth conductive link 232. The second end of the fifth conductive link 232 is connected to the first end of a second interior partial loop 218b of the second part 208. A second end of the second interior partial loop 218b is connected to a first end of a sixth conductive link 236. A second end of the conductive link 236 is connected to a first end of a second exterior partial loop 210b of the first part 206. A second end of the second exterior partial loop 210b is connected to the second terminal 204.

The exterior partial loops 210a and 210b together form an exterior loop of the first part 206 of the inductor 200. The exterior partial loops 222a and 222b together form an exterior loop 222 of the second part 208 of the inductor 200. The interior partial loops 218a and 218b together form an interior loop 218 of the second part 208 of the inductor 200.

The terminals 202 and 204, the interior and exterior loops of the first part 206 and second part 208 and the conductive links 214, 228 and 232 are formed in a first conductive layer of the inductor 200.

The three conductive links 220, 224 and 236 are formed in part in a second conductive layer of the inductor 200.

The inductive loops of the first part 206 and second part 208 are arranged such that current flows through them with opposite rotation, in other words the current flows clockwise in the loops of one part, and counter-clockwise in the loops of the other part. For example, when a current is flowing from the terminal 202 to the terminal 204 of the inductor, in a direction indicated by the arrows in FIG. 2, the current is flowing clockwise in the exterior loop 210 and in the interior loop 226 of the first part 206 and counter-clockwise in the exterior loop 222 and in the interior loop 218 of the second part 208. Similarly, when a current is flowing in the opposite direction to the direction of the arrows, that is from the terminal 204 to the terminal 202 of the inductor, the current is flowing counter-clockwise in the exterior loop 210 and in the interior loop 226 of the first part 206 and clockwise in the exterior loop 222 and in the interior loop 218 of the second part 208. Since the current is flowing in the same direction in each loop of a given part of the inductor 200, the inductance of these loops adds up. However, from a distance, the magnetic field generated by the first part 206 of the inductor 200 still at least partially cancels the magnetic field generated by the second part 208 of the inductor 200.

The inductor 200 has twice as many loops as the inductor 100 of FIG. 1, so for similar loop dimensions, its inductance can be about twice as high as that of the inductor 100.

It can be seen that the inductor 100 of FIG. 1 has one crossing point, which is defined as a point where, in a plan view, the conductive links between conductive tracks in the first conductive layer cross each other, and a second conductive layer is used for one of the links to avoid a short circuit. In contrast, the inductor 200 has three crossing points. Each additional crossing point causes an increase in resistance and capacitance of the inductor and therefore a decrease in the quality factor and an increase in the energy consumption of the inductor. A quality factor of an inductance is defined by the ratio of its inductive reactance to its resistance at a given frequency. When the dimensions of the inductor 200 are such that its inductance matches that of the inductor 100, the inductor 200 is estimated to have a quality factor reduced by five with respect to the quality factor of the inductor 100, the loss being attributed to the larger number of crossing points. The increase in capacitance comes from the superposition of two conductive tracks at the position of the crossing point. Furthermore, in the case that the second conductive layer is closer to the substrate than the first conductive layer, there is, for example, a higher capacitance between the second conductive layer and the substrate than between the first conductive layer and the substrate.

Using a similar layout to the one of FIG. 2, but choosing to have six loops instead of four, or in other words to have three loops in each part of the inductor instead of two, would result in 8 crossing points. Similarly, there would be 15 crossing points for 8 loops and 24 crossing points for 10 loops. Therefore, the number of crossing points increases in a non-linear fashion with respect to the number of loops. This means that, although the inductance value of the figure eight-shaped inductor increases with the increased number of loops, the quality factor decreases significantly.

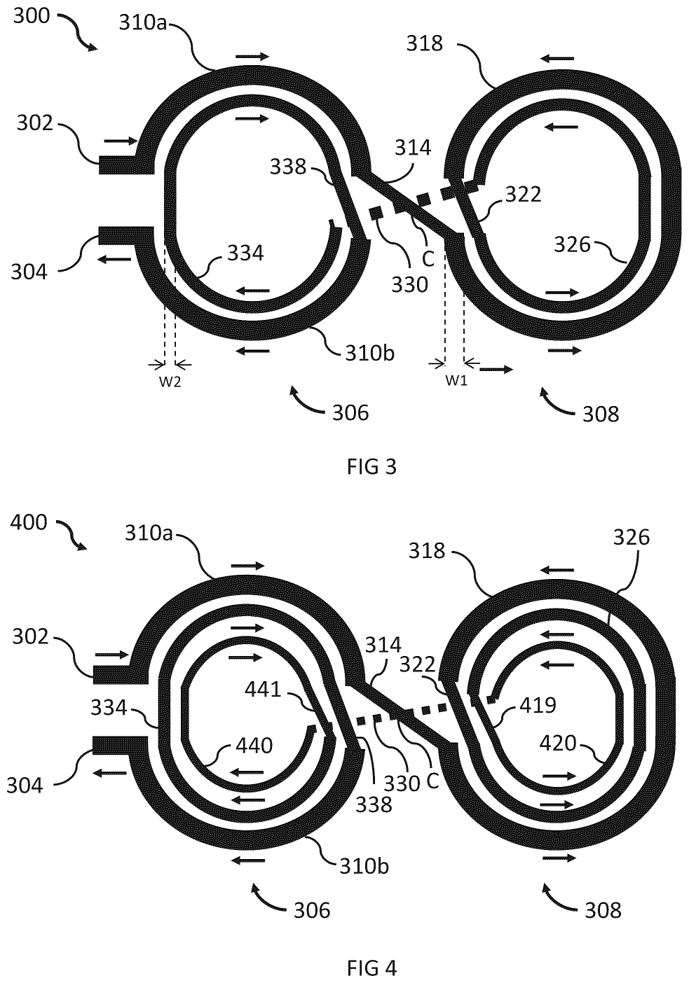

FIG. 3 illustrates a figure eight-shaped inductor 300 comprising four loops.

The inductor 300 is formed in a circuit comprising a stack of insulating and conducting layers lining a substrate (not illustrated in FIG. 3).

The inductor 300 comprises a first terminal 302 and a second terminal 304 that are configured to be coupled or connected to other electronic components (not illustrated in FIG. 3) and each of which is configured to receive and/or supply a current. The figure eight-shaped inductor 300 comprises a first part 306 of the figure eight shape connected to the terminals 302, 304, and a second part 308 of the figure eight shape. The first part 306 comprises an exterior partial loop 310a. A first end of the exterior partial loop 310a is connected to the first terminal 302 and a second end of the exterior partial loop 310a is connected to a first end of a first conductive link 314. A second end of the first conductive link 314 is connected to a first end of an external loop 318 of the second part 308 of the inductor 300. A second end of the external loop 318 is connected to a first end of a second conductive link 322. A second end of the conductive link 322 is connected to a first end of an interior loop 326 of the second part 308. A second end of the interior loop 326 is connected to the first end of a third conductive link 330. A second end of the third conductive link 330 is connected to the first end of an interior loop 334 of the first part 306. A second end of the interior loop 334 is connected to a first end of a fourth conductive link 338. A second end of the conductive link 338 is connected to a first end of an exterior partial loop 310b of the first part 306. A second end of the exterior partial loop 310b is connected to the second terminal 304.

The exterior partial loops 310a and 310b together form an exterior loop of the first part 306 of the inductor 300.

The inductive loops of the first part 306 and second part 308 are arranged such that current flows through them with opposite rotation, in other words the current flows clockwise in the loops of one part, and counter-clockwise in the loops of the other part. For example, when current is flowing from the terminal 302 to the terminal 304 of the inductor 300, in a direction indicated by arrows in FIG. 3, the current is flowing clockwise in the exterior loop 310 and the interior loop 334 of the first part 306 and the current is flowing counter-clockwise in the exterior loop 318 and the interior loop 326 of the second part 308. Similarly, when a current is flowing in the opposite direction to the direction of the arrows, that is from the terminal 304 to the terminal 302 of the inductor, the current is flowing counter-clockwise in the exterior loop 310 and the interior loop 334 of the first part 306 and clockwise in the exterior loop 318 and the interior loop 326 of the second part 308.

Since the current is flowing in the same direction in each loop of a given part of the inductor 300, the inductance of these loops adds up. The inductor 300 has as many loops as the inductor 200 of FIG. 2 so its inductance is similar. The inductor 300 also has the shape of a figure eight so the magnetic field generated by the first part 306 of the inductor is at least partially cancelled by the second part 308 of the inductor and the mutual inductance of the inductor 300 is relatively low. It results that parasitic couplings with neighboring electronic components are also relatively low.

The terminals 302 and 304, the interior and exterior loops of the first part 306 and second part 308 of the inductor 300 and the conductive links 314, 322 and 338 are formed in a first conductive layer of the inductor 300.

The third conductive link 330 is formed in part in a second conductive layer of the inductor 300.

In one embodiment, the second conductive layer is, for example, closer to the substrate than the first conductive layer. The capacitance between the first conductive layer and the substrate is, for example, lower than the capacitance between the second conductive layer and the substrate.

In other embodiments, the first conductive layer is closer to the substrate than the second conductive layer.

The third conductive link 330 comprises a first via at its first end and a second via at its second end to connect the first conductive layer to the second conductive layer.

The inductor 300 has four loops, two loops in each part, and only one crossing point: only one conductive link is in the second conductive layer. Therefore, when the dimensions of the inductor 300 are such that its inductance matches that of the inductor 200, the inductor 300 has a higher quality factor and a lower energy consumption than the inductor 200.

In one embodiment, the first conductive layer is less resistive than the second layer. Reducing the number of crossing points further reduces the resistance of the inductor 300.

According to one embodiment, the exterior loops 310 and 318 have a first width W1 and the interior loops 326 and 334 have a second width W2. For example, the width W1 is larger than the width W2.

According to one embodiment, a radius of curvature of the exterior partial loops 310a and 310b is similar to a radius of the exterior loop 318 and a radius of the interior loop 326 is similar to a radius of the interior loop 334.

According to one embodiment, the loops 310 and 334 of the first part 306 are concentric and the loops 318 and 326 of the second part 308 are concentric.

FIG. 4 illustrates a figure eight-shaped inductor 400 comprising six loops.

Some elements of FIG. 4 are similar to elements of FIG. 3. They are referenced with the same references and will not be described in detail again.

In the case that each part of the figure eight-shaped inductor 400 comprises three or more concentric loops, each of the loops except for the exterior loop will be referred to herein as an “interior loop” of the inductor.

In the following description of FIG. 4, given that each part 306, 308 of the inductor 400 comprises three loops, the interior loop 334 of the first part 306 of the inductor 300 is referred to as an intermediate loop 334 and the interior loop 326 of the second part 308 of the inductor 300 is referred to as an intermediate loop 326.

With respect to the inductor 300, the first part 306 of the inductor 400 has one additional conductive link 441 and one additional interior loop 440 and the second part 308 of the inductor 400 has one additional conductive link 419 and one additional interior loop 420. The conductive link 419 has a first end connected to the second end of the intermediate loop 326 of the second part 308 of the inductor 400 and a second end connected to a first end of the interior loop 420 of the second part 308. With respect to the inductor 300, the third conductive link 330 of FIG. 3 now has its first end connected to a second end of the interior loop 420 of the second part 308. The conductive link 441 has a first end connected to the first end of the intermediate loop 334 of the first part 306 of the inductor 400 and a second end connected to a first end of the interior loop 440 of the first part 306. With respect to the inductor 300, the third conductive link 330 of FIG. 3 now has its second end connected to a second end of the intermediate loop 440 of the first part 306.

Like in FIG. 3, the inductive loops of the first part 306 and second part 308 of the inductor 400 are arranged such that current flows through them with opposite rotation, in other words the current flows clockwise in the loops of one part, and counter-clockwise in the loops of the other part. For example, when current is flowing from the terminal 302 to the terminal 304 of the inductor 400, in a direction indicated by arrows in FIG. 4, the current is flowing clockwise in the exterior loop 310, the intermediate loop 334 and the interior loop 340 of the first part 306 and the current is flowing counter-clockwise in the exterior loop 318, the intermediate loop 326 and the interior loop 420 of the second part 308. Similarly, when a current is flowing in the opposite direction to the direction of the arrows, that is from the terminal 304 to the terminal 302 of the inductor, the current is flowing counter-clockwise in the exterior loop 310, the intermediate loop 334 and the interior loop 440 of the first part 306 and clockwise in the exterior loop 318, the intermediate loop 326 and the interior loop 420 of the second part 308.

Using the layout of FIG. 3 or FIG. 4, it is possible to increase the number of loops of the inductor 100 of FIG. 1, by increasing the number of interior loops in each part, without increasing the number of crossing points. The inductor has one conductive link in the second conductive layer, connecting one end of the most interior loop of the first part 306 of the inductor to one end of the most interior loop of the second part 308 of the inductor.

Therefore, it is possible to increase the inductance value of the inductor 100 without deteriorating its quality factor. Increasing the number of loops increases the inductance value without increasing the area of the inductance.

While examples have been described with reference to FIGS. 3 and 4 in which the figure eight-shaped inductor 300, 400 comprises four or six loops, in alternative embodiments, the same design principal of FIGS. 3 and 4 could be applied to inductors having a different number of loops, for example more than six loops. In some embodiments, the number of loops of the inductor is even with the same number of loops in each part of the inductor. The loops of each part are for example concentric. The width of the loops of each part decreases, for example, with each loop, when going from the most exterior loop towards the most interior loop.

Although the terminals 302, 304 of the inductor 300 of FIG. 3 and the inductor 400 of FIG. 4 are positioned so that the length of the partial exterior loops 310a and 310b are similar, thus forming half loops, in other embodiments the lengths of the partial exterior loops 310a and 310b are different from each other, and the sum of the lengths of the partial exterior loops 310a and 310b, for example, remains the same.

In some embodiments, the inductor 300, 400 has a symmetry, except for the presence of the terminals 302, 304 in one part, by rotating 180° around the center of symmetry C of the inductor 300, 400. The center of symmetry C of the inductor 300, 400 corresponds, for example, to the position of the crossing point between the connecting links 314 and 330.

In the various embodiments described above with respect to FIGS. 3 and 4, when it is described that one end of a first loop, or partial loop, of an inductor is connected to one end of a second loop, or partial loop, of the inductor, this is to be understood as having the end of the first loop being, for example, directly connected to the end of the second loop. For example, the end of the first loop is in direct contact with the end of the second loop. In this context, being directed connected means that there is no vertical connection, or via, used between those first and second loops, and there is no partial loop, or entire loop, of the inductance between the end of the first loop and the end of the second loop. For example, the first loop, the second loop and the connection between the first loop and the second loop are within a single conductive layer.

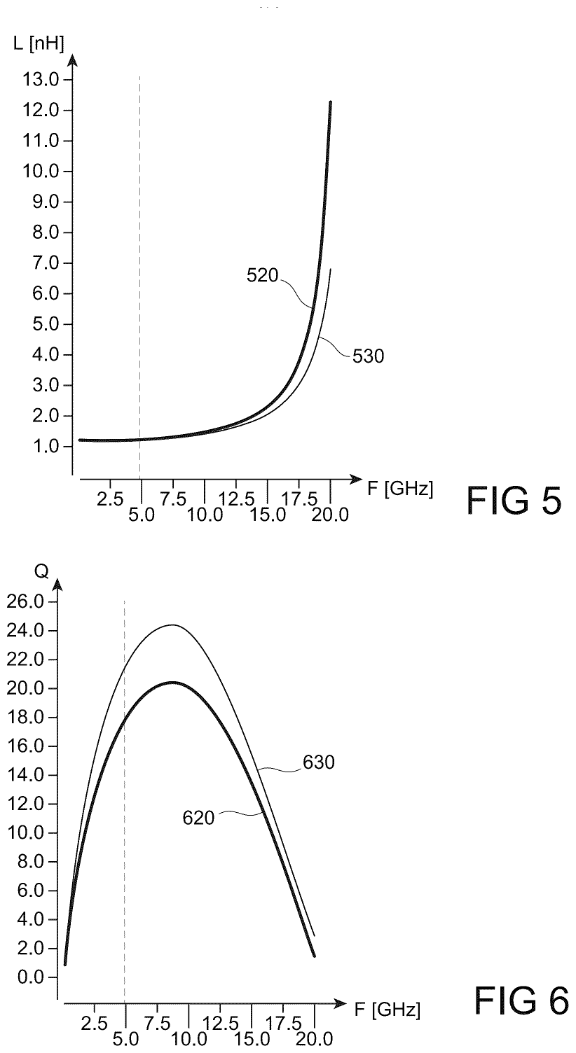

FIG. 5 is a graph showing an example of the inductance value L, in nanohenry, (“L [nH]”) of the inductor 200 of FIG. 2, reference 520, and the inductor 300 of FIG. 3, reference 530, as a function of the frequency of an alternating current F in gigahertz (“F [GHz]”) passing through the inductor.

For an alternating current frequency of 4.88 GHz, the inductances of the inductors 200 and 300 are similar: 1.22 nH for the inductor 200 and 1.20 nH for the inductor 300.

The self-resonance frequency (SRF) is the upper frequency limit of use for an inductor. The SRF is higher for the inductor 300 than for the inductor 200 so the inductor 300 has a wider frequency range of operation and thus a wider range of inductance value.

FIG. 6 is a graph showing an example of the quality factor Q of the inductor 200 of FIG. 2, reference 620, and the inductor 300 of FIG. 3, reference 630, as a function of the frequency of an alternating current F in gigahertz (“F [GHz]”) passing through it.

The quality factor of the inductor 300 is higher than the quality factor of the inductor 200 over the full dynamic range.

At 4.88 GHz, the quality factor of the inductor 200 is 17.74 and the quality factor of the inductor 300 is 21.34. At this frequency of 4.88 GHz, FIG. 5 shows that the inductance values of the inductor 200, 300 are similar and FIG. 6 shows that the quality factor of the inductor 300 is 20% higher than the quality factor of the inductor 200. This corresponds to a decrease in energy consumption of 20%.

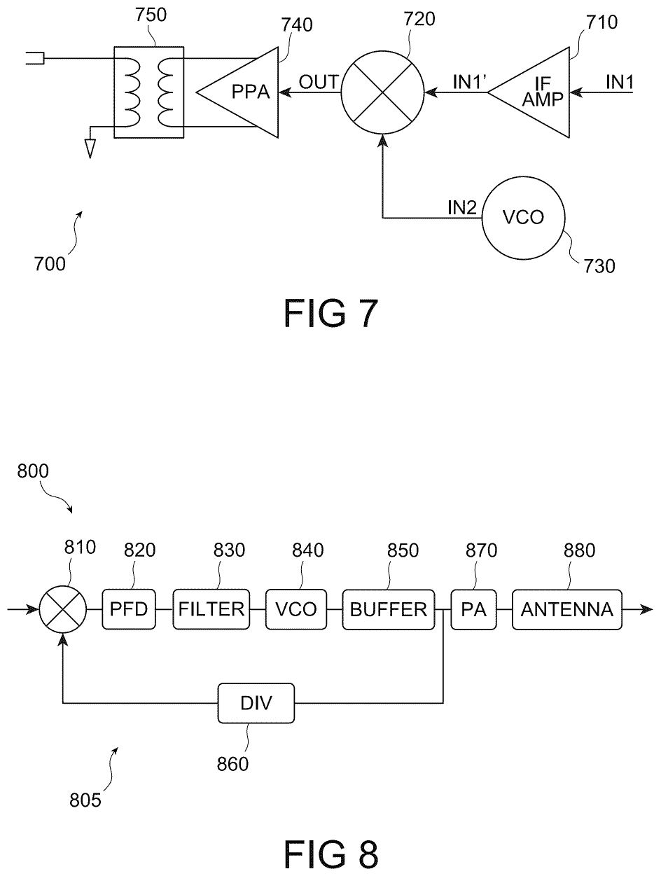

FIG. 7 schematically illustrates a transmitter 700 in which the figure eight-shaped inductor 300 of FIG. 3 or the figure eight-shaped inductor 400 of FIG. 4 may be incorporated.

The transmitter 700 comprises, for example, an intermediate frequency amplifier (“IF AMP”) 710 receiving a first signal IN1 and configured to generate an amplified signal IN1′ by amplifying a range of frequencies of the first signal IN1. A mixer 720 is connected to the output of the intermediate frequency amplifier 710 and receives the signal IN1′ at a first input and receives a second signal IN2 at a second input. The second signal IN2 is, for example, generated by a voltage-controlled oscillator (“VCO”) 730 that is configured to receive a control voltage (not illustrated) and to generate the second signal IN2 at a frequency that is controlled by the control voltage. The VCO 730 comprises an inductor, for example the inductor 300 of FIG. 3 or the inductor 400 of FIG. 4. The mixer 720 is configured to generate an output signal OUT that is a combination of the first signal IN1′ and the second signal IN2. A power amplifier (“PPA”) 740 is, for example, connected to the output of the mixer 720 and is, for example, configured to amplify the output signal OUT. The power amplifier 740 comprises, for example, a balun 750.

A magnetic field generated by the inductor of the VCO 730 may induce an undesirable coupling with the balun 750. Using the figure eight-shaped inductor 300 or 400 to implement the inductor of the VCO 730 results in a relatively low induced inductive coupling while maintaining a relatively high quality factor.

FIG. 8 schematically illustrates another transmitter 800 in which the figure eight-shaped inductor 300, 400 of FIG. 3 or FIG. 4 may be incorporated.

The transmitter 800 comprises, for example, a phase-locked loop (PLL) 805. The PLL comprises, for example, a mixer 810, a phase-frequency divider (“PFD”) 820, a loop filter (“FILTER”) 830, a voltage-controlled oscillator (“VCO”) 840, a buffer (“BUFFER”) 850 and a divider (“DIV”) 860. The operation of a PLL is known to a person skilled in the art and is not detailed. The PLL is, for example, connected to an input of a power amplifier (“PA”) 870. The power amplifier is, for example, configured to amplify an output signal of the PLL and to transmit the amplified signal to an antenna 880.

The VCO 840 of the PLL comprises an inductor. A magnetic field generated by this inductor of the VCO may induce an undesirable coupling with the antenna 880. Using the figure eight-shaped inductor 300, 400 to implement this inductor results in a relatively low induced inductive coupling while maintaining a relatively high quality factor.

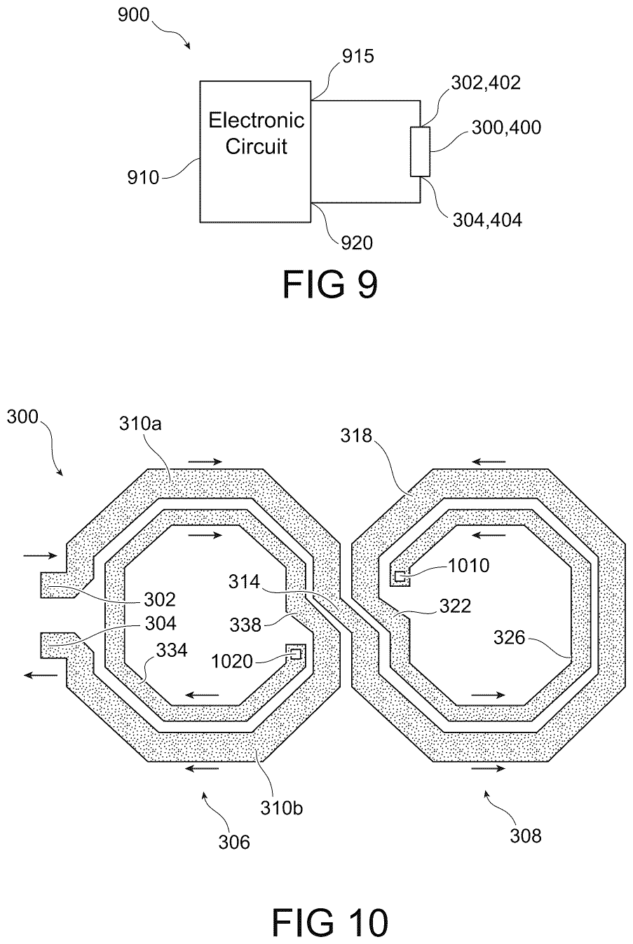

FIG. 9 schematically illustrates an integrated circuit 900 comprising the figure eight-shaped inductor 300 of FIG. 3 or the figure eight-shaped inductor 400 of FIG. 4.

The integrated circuit 900 comprises an electronic circuit 910 that is connected, through a first terminal 915 of the circuit 910, to the first terminal 302, 402 of the inductor 300, 400 and is configured to apply a current to the first terminal 302, 402. The inductor 300, 400 is configured to supply the current at the second terminal 304, 404 which is connected to a second terminal 920 of the electronic circuit 910.

FIG. 10 illustrates a layout of the first conductive layer of the figure eight-shaped inductor 300 of FIG. 3.

Some elements of FIG. 10 are similar to elements of FIG. 3. They are referenced with the same references and will not be described in detail again.

According to the embodiment illustrated in FIG. 10, the inductor 300 has octagonal-shaped loops. In other embodiments, the loops have other shapes, for example circular, square, hexagonal, etc.

The second conductive layer comprising the conductive link 330 of the inductor 300 of FIG. 3 is not illustrated in FIG. 10. A first via 1010 connected to the second end of the interior loop 326 of the second part 308 is configured to connect the first and the second conductive layers. The via 1010 is also connected to the first end of the conductive link 330, not represented on FIG. 10, but shown in FIG. 3. A second via 1020 connected to the first end of the interior loop 334 is configured to connect the first and the second conductive layers. The via 1020 is also connected to the second end of the conductive link 330, not represented in FIG. 10, but shown in FIG. 3.

An example manufacturing method of the figure eight-shaped inductor 300 in a stack of insulating and conducting layers, comprises the following steps. A similar manufacturing method could be used to form the figure eight-shaped inductor 400 of FIG. 4.

According to one embodiment, the method comprises forming, in the first conductive layer of the stack: the terminals 302, 304; the loops 310a, 318, 326, 334, 310b; the conductive links 338, 322 connecting two loops of the first part 306 or two loops of the second part 308; and the conductive link connecting the exterior loop 318 of the second part 308 to the partial exterior loop 310a of the first part 306. The method then comprises, for example, forming: the first via 1010 contacting the second end of the interior loop 326 of the second part 308; and the second via 1020 contacting the first end of the interior loop 334. The method then comprises, for example, forming, in the second conductive layer of the stack, the third conductive link 330 connecting the first via 1010 and the second via 1020.

According to another embodiment, the method comprises forming, in the second conductive layer of the stack, the third conductive link 330. The method then comprises, for example, forming: the first via 1010 contacting the first end of the third conductive link 330; and the second via 1020 contacting the second end of the third conductive link 330. The method then comprises, for example, forming, in the first conductive layer of the stack: the interior loop 326 of the second part 308 having its second end contacting the first via 1010; the interior loop 334 of the second part 308 having its first end contacting the second via 1020; the terminals 302, 304; the loops 310a, 318, 310b; the conductive links 338, 322 connecting two loops of the first part 306 or two loops of the second part 308; and the conductive link connecting the exterior loop 318 of the second part 308 to the partial exterior loop 310a of the first part 306.

In the various embodiments described above, when it is described that one end of a first loop, or partial loop, of an inductor is connected to one end of a second loop, or partial loop, of the inductor, the end of the first loop is for example directly connected to the end of the second loop. For example, the end of the first loop is in direct contact with the end of the second loop. For example, there is no vertical connection, or via, and there is no partial loop, or entire loop, of the inductance between the end of the first loop and the end of the second loop. For example, the first loop, the second loop and the connection between the first loop and the second loop are within a single conductive layer.

Advantages of the embodiments disclosed in the description include a reduced number of crossing points while maintaining a figure eight-shape inductor: the inductor 300 of FIG. 3 and the inductor 400 of FIG. 4 only have one crossing point. Maintaining a low number of crossing points results in a relatively low resistance and capacitance and a relatively high quality factor of the inductor. The energy consumption of the inductor is also relatively low.

Thanks to the low number of crossing points, a relatively high number of loops can be designed and used for figure eight-shaped inductors while maintaining a good quality factor. This enables achieving a relatively high inductance value and/or a relatively low surface area.

The self-resonance frequency is also improved which widens the dynamic range of the inductor.

The inductor as described herein has, for example, numerous applications in various industries. For example, the inductor 300, 400 is incorporated in a device with one or more other components.

The device is, for example, intended for the automotive industry. The electrification of automotive vehicles generates an expanding high level of electronic content in vehicles. The device comprises, for example, thyristors, rectifiers, high voltage transient-voltage-suppression diodes, modules, etc., to be incorporated in said vehicles. The automatization of driving also generates an expanding high level of electronic content in vehicles. The device comprises, for example, high voltage transient-voltage-suppression diodes, protection against electromagnetic discharges and common mode filters to protect against electrical hazards in emerging complex electronics.

The device can, for example, be used in the industrial field. More especially, the device aims, for example, at being used for the development of green energies or for the electrification of infrastructures, for example for charging stations or for the incorporation of solar energy. The device can also be used in the field of the internet of things and of smart homes. The device is, for example, intended for being implemented in the power and energy circuits of pieces of equipment, comprising for example 800V or 1200V thyristors, 1200V ultrafast and silicon carbide diodes, transient-voltage-suppression diodes, and protections against electromagnetic discharges. The device can also be used in the implementation of clouds, 5G networks, data centers and servers. The device comprises, for example, wide band gap materials.

The device is, for example, intended for being used in personal electronics, for example in the aim of increasing radio frequency content, in device of 5G connections or more generally in connected devices. The device is, for example, a smartphone or a part of a network of internet of things. The device is, for example, connected by 5G, WIFI or ultra-white band. The device includes, for example, high speed interfaces, for example with advanced filtering and protection against electromagnetic discharges.

The device is, for example, intended for being used in communication equipment, or in computers and peripherals. For example, the device can be used in 5G infrastructure and dedicated data centers. The device comprises, for example, silicon carbide diodes, power Schottky transistors, protections against electromagnetic discharges and transient-voltage-suppression diodes. The device can also be used in satellites, comprising, for example, integrated passive devices for radio frequency applications.

Various embodiments and variants have been described. Those skilled in the art will understand that certain features of these embodiments can be combined and other variants will readily occur to those skilled in the art. In particular, embodiments can be enlarged to inductors with a different number of loops and/or a different shape for the loops, for example circular, square, etc.

Finally, the practical implementation of the embodiments and variants described herein is within the capabilities of those skilled in the art based on the functional description provided hereinabove.

1. A figure eight-shaped inductor, comprising:
a stack of insulating and conducting layers including a first conductive layer and a second conductive layer;
wherein the first conductive layer comprises:
an exterior loop of a first part of the inductor having a first end connected to an end of a first exterior partial loop of a second part of the inductor and a second end connected to a first end of one or more interior loops of the first part of the inductor, the exterior loop and the one or more interior loops of the first part being concentric; and
one or more interior loops of the second part of the inductor having a first end connected to an end of a second exterior partial loop of the second part of the inductor, the first and second exterior partial loops and the one or more interior loops of the second part being concentric; and
wherein the second conductive layer comprises a conductive link connected through a via to a second end of the one or more interior loops of the first part of the inductor and connected through a via to a second end of the one or more interior loops of the second part of the inductor.

2. The figure eight-shaped inductor according to claim 1, wherein a current flow between a first terminal and a second terminal of the inductor is in a first direction of rotation in both the exterior loop and the one or more interior loops of the first part and is in a second direction of rotation opposite to the first direction in both the first and second exterior partial loops and the one or more interior loops of the second part.

3. The figure eight-shaped inductor according to claim 1, wherein, in the first part, a first width of the exterior loop is larger than a second width of the one or more interior loops and wherein, in the second part, a third width of the first and second exterior partial loops is larger than a fourth width of the one or more interior loops.

4. The figure eight-shaped inductor according to claim 1, wherein stack of insulating and conducting layers extends over a substrate and the second conductive layer is closer to the substrate than the first conductive layer.

5. The figure eight-shaped inductor according to claim 1, wherein stack of insulating and conducting layers extends over a substrate and the first conductive layer is closer to the substrate than the second conductive layer.

6. An integrated circuit comprising the inductor according to claim 1.

7. A voltage-controlled oscillator comprising the inductor according to claim 1.

8. A transmitter comprising the inductor according to claim 1.

9. A method, comprising:
applying a current, by an electronic circuit, to the figure eight-shaped inductor of claim 1, and
transmitting the current through the inductor.

10. The method according to claim 9, wherein:
the current is applied to a first terminal of the figure eight-shaped inductor;
the current is transmitted from the first terminal to a second terminal of the figure eight-shaped inductor; and
the current is output at the second terminal of the figure eight-shaped inductor.

11. A method of manufacturing a figure eight-shaped inductor, comprising:
in a stack of insulating and conducting layers:
forming, in a first conductive layer of the stack, an exterior loop of a first part of the inductor having a first end connected to an end of a first exterior partial loop of a second part of the inductor and a second end connected to a first end of one or more interior loops of the first part of the inductor, the exterior loop and the one or more interior loops of the first part being concentric;
forming, in the first conductive layer of the stack, one or more interior loops of the second part of the inductor having a first end connected to an end of a second exterior partial loop of the second part of the inductor, the first and second exterior partial loops and the one or more interior loops of the second part being concentric.

12. The method of manufacturing the figure eight-shaped inductor according to claim 11, further comprising, after forming the first conductive layer:
forming a first via contacting a second end of the one or more interior loops of the first part of the inductor;
forming a second via, contacting a second end of the one or more interior loops of the second part of the inductor; and
forming, in a second conductive layer of the stack, a conductive link connecting the first via and the second via.

13. The method of manufacturing the figure eight-shaped inductor according to claim 11, further comprising, before forming the first conductive layer:
forming, in a second conductive layer of the stack, a conductive link;
forming a first via, contacting a first end of the conductive link and further contacting a second end of the one or more interior loops of the first part of the inductor; and
forming a second via, contacting a second end of the conductive link and further contacting a second end of the one or more interior loops of the second part of the inductor.
